(19) United States
(12) Patent Application Publication
(10) Pub. No.: US 2014/0340187 A1
(43) Pub. Date: Nov. 20, 2014

(54) POWER TRANSMISSION COIL

(71) Applicant: PANASONIC CORPORATION, Kadoma-shi, Osaka (JP)

(72) Inventors: Steffen Werner, Osaka (JP); Hiroki Iwamiya, Kyoto (JP); Eiji Miyake, Kyoto (JP)

(21) Appl. No.: 14/375,397

(22) PCT Filed: Feb. 4, 2013
(86) PCT No.: PCT/JP2013/000597

§ 371 Date: Jul. 29, 2014

(30) Foreign Application Priority Data
Feb. 10, 2012 (JP) 2012-027260

(51) Int. Cl. H01F 27/28; H01F 38/14

(52) U.S. Cl. CPC H01F 27/2804; H01F 38/14; H01F 2027/2809
USPC 336/200

(57) ABSTRACT

A power transmission coil is unsusceptible to a dimensional error between individual coils or a displacement between primary and secondary coils. The power transmission coil includes a first planar coil having an inner diameter (Di) and a second planar coil having an outer diameter (Do) and being disposed opposite to the first planar coil. The quotient of the outer diameter (Do) of the second planar coil and the inner diameter (Di) of the first planar coil is defined as an inner/outer diameter ratio (Do/Di). The rate of change in the coupling coefficient between the first planar coil and the second planar coil is defined as a coupling coefficient change rate (Δk). The inner diameter (Di) of the first planar coil and the outer diameter (Do) of the second planar coil are determined in accordance with the correlation between the inner/outer diameter ratio (Do/Di) and the coupling coefficient change rate (Δk) so that the inner/outer diameter ratio (Do/Di) has a value not more than the value at which the slope of the correlation begins to rise steeply.

### TECHNICAL FIELD

The present invention relates to a power transmission coil that transmits electric power wirelessly.

### BACKGROUND ART

Wireless power feed technology to transmit power wirelessly with no direct electric connection has been developed in recent years. A wireless power transmission device based on the wireless power feed technology is proposed in Patent Literature 1. FIG. 8 shows a perspective view of this wireless power transmission device.

The wireless power transmission device shown in FIG. 8 includes primary coil 101 and secondary coil 102, which are disposed opposite in the axial direction. The outer diameter of secondary coil 102 is smaller than the outer diameter of primary coil 101. The wireless power transmission device further includes soft magnetic materials 103 and 104 disposed outside primary coil 101 and secondary coil 102, respectively, in the axial direction.

Primary coil 101 and secondary coil 102 are positioned so that their central axes coincide. Now, secondary coil 102 is moved in the direction perpendicular to the axial direction. The travel distance of secondary coil 102 in which the magnetic coupling coefficient between the two coils has a reduction rate of 20% is defined as an attenuation distance with k0.8. FIG. 9 is a graph showing the relationship between the ratio of the outer diameter of secondary coil 102 to the outer diameter of primary coil 101 (the outer diameter of the secondary coil/the outer diameter of the primary coil) and the attenuation distance with k0.8. As understood from FIG. 9, the attenuation distance with k0.8 increases with decreasing ratio of the outer diameter of secondary coil 102 to the outer diameter of primary coil 101. In other words, the smaller the outer diameter of secondary coil 102 relative to that of primary coil 101, the larger the attenuation distance with k0.8. Thus, power transmission is more stable in a wider range in the case that the outer diameter of secondary coil 102 is smaller than that of primary coil 101 than in the case that the diameters of the two coils are identical.

### CITATION LIST

### Patent Literature

Patent Literature 1: Japanese Unexamined Patent Publication No. 2009-188131

### SUMMARY OF THE INVENTION

The wireless power transmission device shown in FIG. 8 performs stable power transmission. As understood from FIG. 9, for example in the case that the ratio of the outer diameter of secondary coil 102 to the outer diameter of primary coil 101 (the outer diameter ratio) is 1, the attenuation distance with k0.8 is 2 mm. In the case that the outer diameter ratio is 0.3, the attenuation distance with k0.8 is 14 mm, which is about seven times as large as in the former case. Thus, the attenuation distance with k0.8 varies depending on the error between the outer diameters of individual secondary coils 102 and the error between the outer diameters of individual primary coils 101. The variation in the attenuation distance with k0.8 results in a variation in the magnetic coupling coefficient (hereinafter, the coupling coefficient) between the primary and secondary coils, which is used to calculate the attenuation distance with k0.8. As a result, the power transmission efficiency, which is expressed as the function of the coupling coefficient, may differ depending on the individual coils.

An object of the present invention is to provide a power transmission coil that is unsusceptible to a dimensional error between individual coils or a displacement between primary and secondary coils.

The power transmission coil of the present invention includes a first planar coil having an inner diameter (Di) and a second planar coil having an outer diameter (Do) and is disposed opposite to the first planar coil. The quotient of the outer diameter (Do) of the second planar coil and the inner diameter (Di) of the first planar coil is defined as an inner/outer diameter ratio (Do/Di). The rate of change in the coupling coefficient between the first planar coil and the second planar coil is defined as the coupling coefficient change rate (Δk).

There is a correlation between the inner/outer diameter ratio (Do/Di) and the coupling coefficient change rate (Δk) . The inner diameter (Di) of the first planar coil and the outer diameter (Do) of the second planar coil are determined in accordance with the correlation so that the inner/outer diameter ratio (Do/Di) has a value not more than the value at which the slope of the correlation begins to rise steeply.

In the power transmission coil of the present invention, the inner diameter Di of the first planar coil and the outer diameter Do of the second planar coil are determined so that the inner/outer diameter ratio Do/Di has a value not more than the value at which the slope of the correlation begins to rise steeply. This stabilizes the coupling coefficient change rate Δk between the first planar coil having the determined inner diameter Di and the second planar coil having the determined outer diameter Do. The stabilized coupling coefficient change rate Δk allows the change in magnetic field across the two coils to be comparatively stable. As a result, the power transmission coil is unsusceptible to a dimensional error between individual coils or a displacement between the primary and secondary coils.

### BRIEF DESCRIPTION OF DRAWINGS

FIG. 1 is a perspective view of a power transmission coil of a first exemplary embodiment of the present invention.

FIG. 2 is a sectional view of the power transmission coil of the first exemplary embodiment of the present invention.

FIG. 3 is a graph showing the relationship between an inner/outer diameter ratio Do/Di and a coupling coefficient change rate Δk in the power transmission coil of the first exemplary embodiment of the present invention.

FIG. 4 is a perspective view of a power transmission coil of a second exemplary embodiment of the present invention.

FIG. 5 is a perspective view of a power transmission coil of a third exemplary embodiment of the present invention.

FIG. 6 is a perspective view of a power transmission coil of a fourth exemplary embodiment of the present invention.

FIG. 7 is a perspective view of a power transmission coil of a fifth exemplary embodiment of the present invention.

FIG. 8 is a perspective view of a conventional wireless power transmission device.

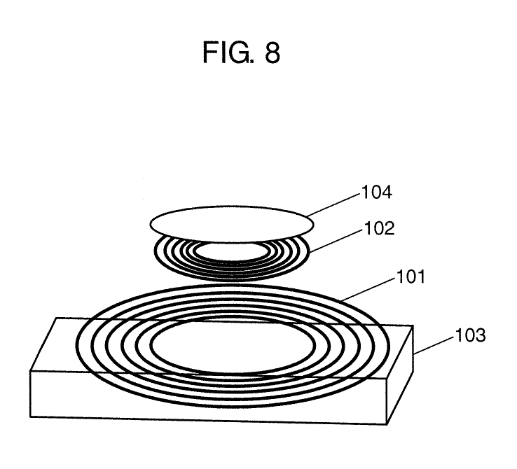

FIG. 9 is a graph showing the relationship between the ratio of the outer diameter of the secondary coil to the outer diameter of the primary coil (the outer diameter of the secondary coil/the outer diameter of the primary coil) and the attenuation distance with k0.8 in the conventional wireless power transmission device.

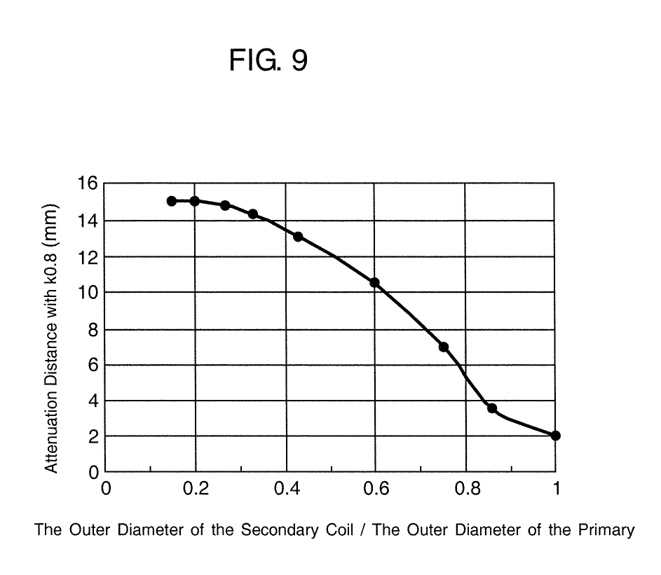

### DESCRIPTION OF EMBODIMENTS

Embodiments of the present invention will now be described with reference to the drawings.

### First Exemplary Embodiment

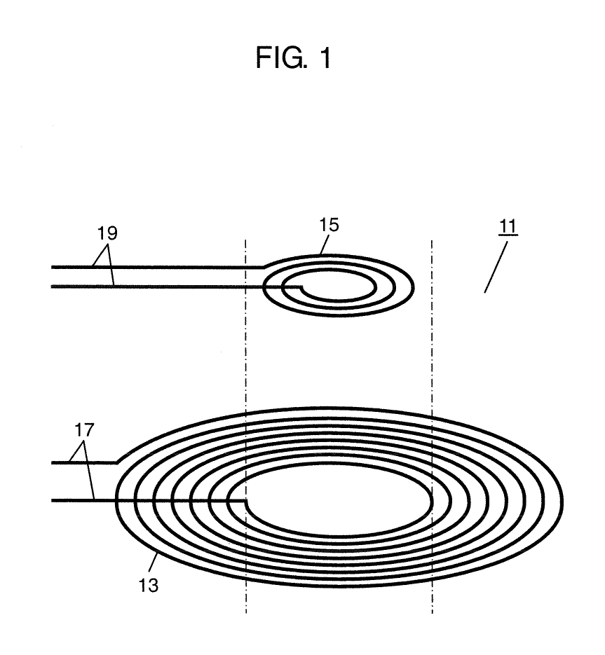

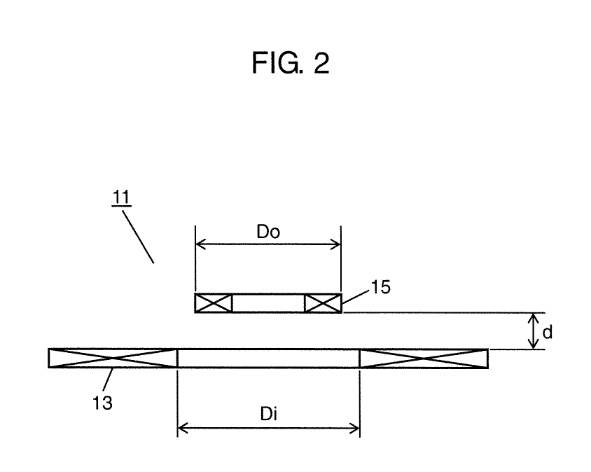

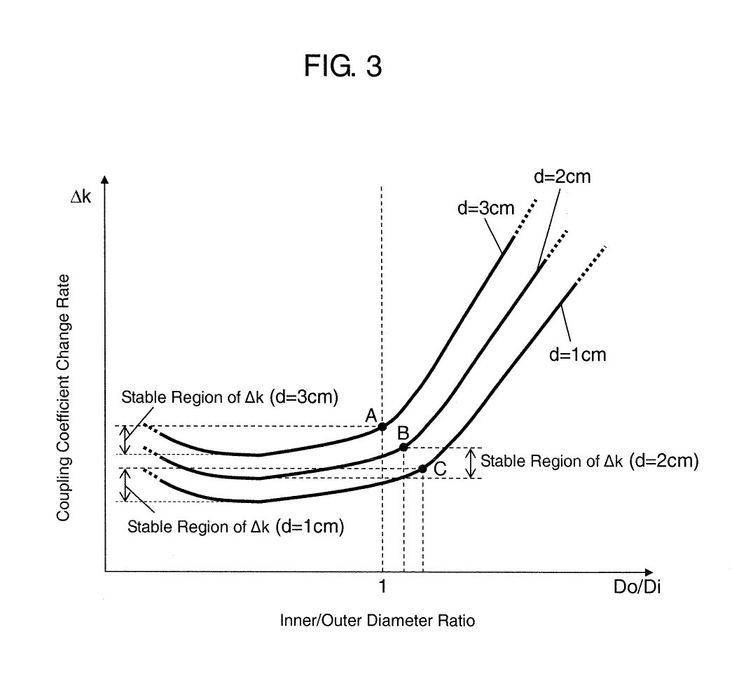

FIG. 1 is a perspective view of a power transmission coil of a first exemplary embodiment of the present invention. FIG. 2 is a sectional view of the power transmission coil. FIG. 3 is a graph showing the relationship between an inner/outer diameter ratio Do/Di and a coupling coefficient change rate Δk in the power transmission coil.

In FIG. 1, power transmission coil 11 includes first planar coil 13 having an inner diameter Di, and second planar coil 15 having an outer diameter Do and being disposed opposite to first planar coil 13. The quotient of the outer diameter Do of second planar coil 15 and the inner diameter Di of first planar coil 13 is hereinafter defined as the inner/outer diameter ratio Do/Di. The rate of change in the coupling coefficient between first planar coil 13 and second planar coil 15 is hereinafter defined as the coupling coefficient change rate Δk. There is a correlation between the inner/outer diameter ratio Do/Di and the coupling coefficient change rate Δk. The inner diameter Di and the outer diameter Do are determined in accordance with the correlation so that the inner/outer diameter ratio Do/Di has a value not more than the value at which the slope of the correlation begins to rise steeply.

This stabilizes the coupling coefficient change rate Δk between first planar coil 13 having the determined inner diameter Di and second planar coil 15 having the determined outer diameter Do. The stabilized coupling coefficient change rate Δk comparatively reduces the change in magnetic field across first planar coil 13 and second planar coil 15. As a result, power transmission coil 11 has a stable coupling coefficient change rate even if there is a dimensional error between individual coils or a displacement between the primary and secondary coils.

The construction and operation of power transmission coil 11 of the present first exemplary embodiment will now be described in detail.

In FIG. 1, power transmission coil 11 includes first planar coil 13 that transmits power. First planar coil 13 is made of litz wire, which is spirally wound from the outside toward the center of first planar coil 13. Both ends of first planar coil 13 are connected to an unillustrated power transmission circuit via first-planar-coil lead-out wires 17.

Power transmission coil 11 further includes second planar coil 15, which is disposed opposite to first planar coil 13 and receives electric power from first planar coil 13. Second planar coil 15 is also made of litz wire, which is spirally wound from the outside toward the center of second planar coil 15 in the same manner as in first planar coil 13. Both ends of second planar coil 15 are connected to an unillustrated power reception circuit via second-planar-coil lead-out wires 19.

First planar coil 13 and second planar coil 15 are defined as the portions that are spirally wound with precision and that contribute mainly to power transmission as shown in FIG. 1. In other words, even if a loop portion is formed by, for example, routing first-planar-coil lead-out wires 17 or second-planar-coil lead-out wires 19, the loop portion is not included in first planar coil 13 or second planar coil 15.

The size relationship between first planar coil 13 and second planar coil 15 will now be described. FIG. 2 is a diametrical sectional view of power transmission coil 11 shown in FIG. 1. As shown in FIG. 2, the inner diameter Di of first planar coil 13 is made not less than the outer diameter Do of second planar coil 15. The spacing d between first planar coil 13 and second planar coil 15 is defined as the distance between the upper surface of first planar coil 13 and the lower surface of second planar coil 15 shown in FIG. 2. The inner diameter Di and the outer diameter Do indicate the dimensions of the region where an effective magnetic flux is generated. These diameters approximately agree with the actual dimensions (the actually measured dimensions), and therefore, the inner diameter Di and the outer diameter Do are regarded as their actual dimensions in the present first exemplary embodiment.

How to determine the inner diameter Di and the outer diameter Do will now be described with reference to FIG. 3. FIG. 3 is a graph showing the relationship between the inner/outer diameter ratio Do/Di and the coupling coefficient change rate Δk in power transmission coil 11. The horizontal axis represents the inner/outer diameter ratio Do/Di, and the vertical axis represents the coupling coefficient change rate Δk. The inner/outer diameter ratio Do/Di is defined as the quotient of the outer diameter Do of second planar coil 15 and the inner diameter Di of first planar coil 13. In the case that first planar coil 13 and second planar coil 15 are positioned so that their central axes coincide as shown in FIG. 2, the coupling coefficient is defined as k0. In the case that second planar coil 15 is moved by a predetermined distance (for example, 5 cm) in the horizontal direction, the coupling coefficient is defined as k5. The coupling coefficient change rate Δk, which represents the rate of change in the coupling coefficient, is calculated by the equation Δk=|k5−k0|/k0. Thus, as the coupling coefficient change rate Δk is smaller, power transmission coil 11 is less vulnerable to a dimensional error between individual coils or a displacement between the primary and secondary coils. FIG. 3 shows the actually measured coupling coefficient change rates Δk of different combinations of first planar coils 13 and second planar coils 15 that are experimentally produced so as to be different in the inner/outer diameter ratio Do/Di.

As understood from FIG. 3, in the case that the inner/outer diameter ratio Do/Di is sufficiently large in accordance with its correlation with the coupling coefficient change rate Δk, there is a point at which the slope of this correlation begins to rise steeply, regardless of the spacing d. The steep rise in the slope of the correlation means that the value of the slope increases over the error range. In other words, the rise in the slope of the correlation obtained under the influence of the errors contained in the inner diameter Di, the outer diameter Do, and the coupling coefficient change rate Δk is within the error range of the slope value and does not cause a steep rise. Hence, a rise in the slope of the correlation exceeding the error range is defined as the steep rise in the slope.

The steep rise in the slope will now be described more specifically with reference to FIG. 3. In the case that the spacing d is 3 cm, the slope of the correlation begins to rise steeply at point A. At point A, the inner/outer diameter ratio Do/Di has a maximum value in a region where the slope is comparatively small and the coupling coefficient change rate Δk is stable. This region corresponds to the region indicated by “the stable region of Δk (d=3 cm) ” in FIG. 3. In this case the inner/outer diameter ratio Do/Di is just 1. Thus, in the case that the spacing d is 3 cm, the inner diameter Di and the outer diameter Do are determined so that the inner/outer diameter ratio Do/Di has a value not more than the value (=1) at which the slope of the correlation begins to rise steeply. As a result, the coupling coefficient change rate Δk is stable as shown in FIG. 3. Hence, the change in magnetic field across first planar coil 13 and second planar coil 15 is comparatively stable. This reduces the influence of a dimensional error between individual coils or a displacement between the primary and secondary coils, if any.

In the case that the spacing d is 2 cm, the slope of the correlation begins to rise steeply at point B as shown in FIG. 3. At point B, the inner/outer diameter ratio Do/Di has a maximum value in a region where the slope is comparatively small and the coupling coefficient change rate Δk is stable. This region corresponds to the region indicated by “the stable region of Δk (d=2 cm) ” in FIG. 3. In this case the inner/outer diameter ratio Do/Di is larger than 1. In a similar manner, in the case that the spacing d is 1 cm, the slope of the correlation begins to rise steeply at point C as shown in FIG. 3. The inner/outer diameter ratio Do/Di in this case has a value larger than the value in the case with point B. Thus, as the spacing d is smaller, the value of the inner/outer diameter ratio Do/Di at which the slope of the correlation begins to rise steeply tends to increase. In any of these cases, the inner diameter Di and the outer diameter Do are determined so that the inner/outer diameter ratio Do/Di has a value not more than the value at which the slope of the correlation begins to rise steeply. This stabilizes the coupling coefficient change rate Δk, thereby reducing the influence of a dimensional error between individual coils or a displacement between the primary and secondary coils, if any.

From the above, in the case that power transmission coil 11 has a determined spacing d, the inner diameter Di and the outer diameter Do can be determined from the value of the inner/outer diameter ratio Do/Di at which the slope of the correlation begins to rise steeply depending on the spacing d as shown in FIG. 3.

In a power transmission system in which the spacing d varies, the inner diameter Di and the outer diameter Do can be determined so that the inner/outer diameter ratio Do/Di has a value not more than point A or not more than 1 in which case the coupling coefficient change rate Δk is stable even if the spacing d varies in the range of 1 to 3 cm as shown in FIG. 3. As a result, power transmission coil 11 is unsusceptible to a dimensional error between individual coils or a displacement, regardless the variation of the spacing d.

As shown in FIG. 3, however, in the case that the inner/outer diameter ratio Do/Di has too small a value, the coupling coefficient change rate Δk is slightly high. This tends to cause the slope of the correlation to have a negative value. The reason for this is as follows. The smaller the inner/outer diameter ratio Do/Di, the smaller second planar coil 15 relative to first planar coil 13, and therefore, second planar coil 15 is highly affected by the change in the position where a magnetic field of first planar coil 13 is generated. Hence, the smaller the inner/outer diameter ratio Do/Di, the larger the coupling coefficient change rate Δk. In addition, in this case, second planar coil 15 is extremely small relative to first planar coil 13, making sufficient power transmission impossible. Thus, as long as second planar coil 15 is large enough to allow sufficient power transmission, the variation in the coupling coefficient change rate Δk tends to be smaller in the case that inner/outer diameter ratio Do/Di is smaller, rather than larger, than the value of the inner/outer diameter ratio Do/Di at which the slope of the correlation begins to rise steeply as shown in FIG. 3. Therefore, when used for the application that does not require the coupling coefficient change rate Δk to be small, power transmission coil 11 is less vulnerable to a dimensional error between individual coils or a displacement between the primary and secondary coils in the case that the inner/outer diameter ratio Do/Di is smaller, rather than larger, than the value of the inner/outer diameter ratio Do/Di at which the slope of the correlation begins to rise steeply.

In this construction, the inner diameter Di and the outer diameter Do are determined so that the inner/outer diameter ratio Do/Di has a value not more than the value at which the slope of the correlation begins to rise steeply. This stabilizes the coupling coefficient change rate Δk between first planar coil 13 having the determined inner diameter Di and second planar coil 15 having the determined outer diameter Do. The stabilized coupling coefficient change rate Δk allows the change in magnetic field across the two coils to be comparatively stable. As a result, power transmission coil 11 is unsusceptible to a dimensional error between individual coils or a displacement between the primary and secondary coils.

First planar coil 13 is used for power transmission, and second planar coil 15 is used for power reception in the present first exemplary embodiment. Even, however, if they are used the other way around, the effects similar to those described in the present first exemplary embodiment can be obtained.

First planar coil 13 and second planar coil 15 are both circular in the present first exemplary embodiment as shown in FIG. 1; however, they may alternatively be polygonal. In this case, the inner diameter Di and the outer diameter Do can be determined by approximating a polygon into a circular shape (for example, a circle tangent to the each side of the polygon, a circumscribed circle, or an inscribed circle).

### Second Exemplary Embodiment

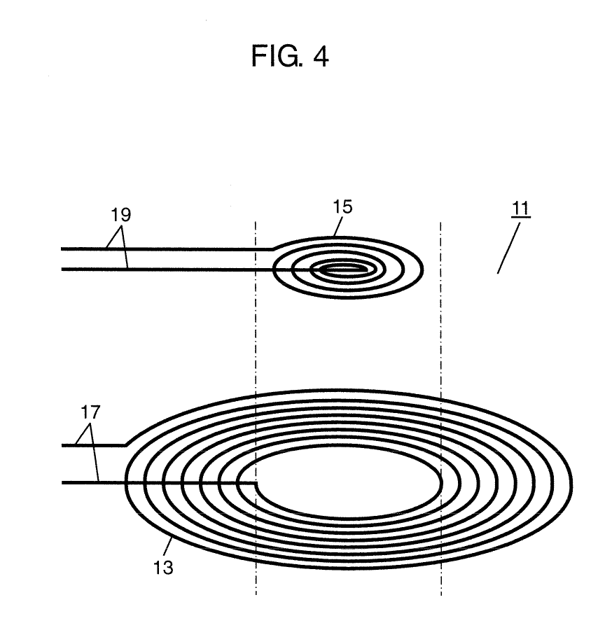

FIG. 4 is a perspective view of a power transmission coil of a second exemplary embodiment of the present invention.

In FIG. 4, second planar coil 15 of power transmission coil 11 is wound as close to its center as possible. For example, second planar coil 15 is wound to its center where second planar coil 15 is connected to one of second-planar-coil lead-out wires 19.

In this configuration, the smaller the inner diameter of second planar coil 15, the more stable the magnetic field between the two coils. As a result, power transmission coil 11 is much less susceptible to a dimensional error between individual coils or a displacement between the primary and secondary coils.

The construction and operation of power transmission coil 11 of the present second exemplary embodiment will now be described in detail. In FIG. 4, like components are labeled with like reference numerals with respect to FIG. 1, and the following description will be focused on the features of the second exemplary embodiment.

As shown in FIG. 4, second planar coil 15 is wound from the outside as close to its center so far as the diameter of the litz wire used for second planar coil 15 allows. In other words, the inner diameter of second planar coil 15 is made as small as possible. With this configuration, even if first planar coil 13 and second planar coil 15 are displaced from each other, the two coils overlap more with each other than they do in the configuration shown in FIG. 1 when viewed vertically. This ensures the magnetic coupling between the two coils even if there is a displacement therebetween, thereby stabilizing the magnetic field between the two coils. As a result, power transmission coil 11 is much less susceptible to a dimensional error between individual coils or a displacement between the primary and secondary coils.

### Third Exemplary Embodiment

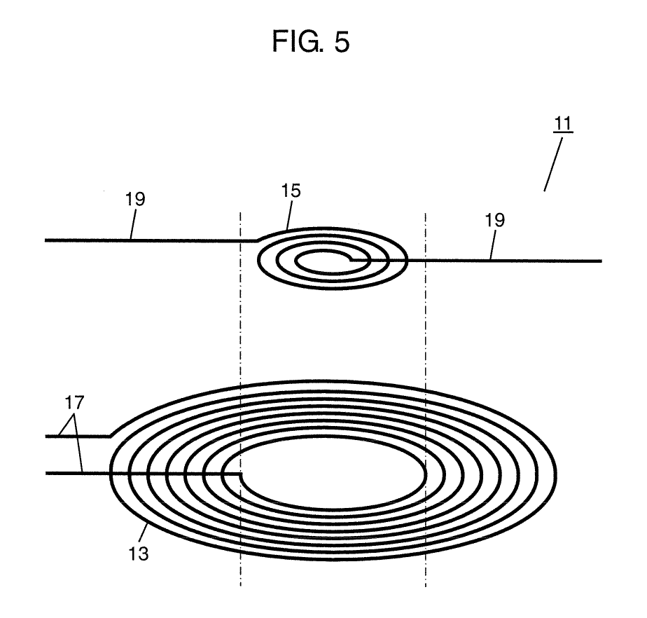

FIG. 5 is a perspective view of a power transmission coil of a third exemplary embodiment of the present invention.

As shown in FIG. 5, two second-planar-coil lead-out wires 19 extend in opposite directions, one at each end of power transmission coil 11.

In this configuration, the influence of the loop coil formed by second-planar-coil lead-out wires 19 on the magnetic field between first planar coil 13 and second planar coil 15 is eliminated. This further stabilizes the coupling coefficient change rate Δk. As a result, power transmission coil 11 is unsusceptible to a dimensional error between individual coils or a displacement between the primary and secondary coils.

The construction and operation of power transmission coil 11 of the present third exemplary embodiment will now be described in detail. In FIG. 5, like components are labeled with like reference numerals with respect to FIG. 1, and the following description will be focused on the features of the third exemplary embodiment.

In FIG. 5, two second-planar-coil lead-out wires 19 connected to second planar coil 15 extend in opposite directions (180 degrees apart from each other in FIG. 5). This configuration prevents second-planar-coil lead-out wires 19 from forming a loop coil. Back in the configuration shown in FIG. 1, two second-planar-coil lead-out wires 19 are led out in the same direction, thereby forming one turn of loop coil in the space above first planar coil 13. In contrast, the configuration shown in FIG. 5 does not form such a loop coil.

If an unnecessary loop coil is formed, it may affect the magnetic field between first planar coil 13 and second planar coil 15, depending on the size and the number of turns of second planar coil 15. More specifically, if second planar coil 15 is displaced to the left from where it is shown in FIG. 1, this displacement changes the area where first planar coil 13 overlaps the unnecessary loop coil formed in the space above first planar coil 13 when viewed vertically. This may increase the coupling coefficient change rate Δk, depending on the direction in which second planar coil 15 is displaced.

In contrast, as mentioned above, the configuration shown in FIG. 5 does not form an unnecessary loop coil, thereby preventing the coupling coefficient change rate Δk from being affected by the unnecessary loop coil, in whichever direction second planar coil 15 is displaced. This further stabilizes the coupling coefficient change rate Δk.

As shown in FIG. 5, two second-planar-coil lead-out wires 19 extend in two directions 180 degrees apart from each other in the present exemplary embodiment; however, the angle difference is not limited to 180 degrees. As long as two second-planar-coil lead-out wires 19 extend in different directions, the magnetic field between first planar coil 13 and second planar coil 15 is less susceptible to the unnecessary loop coil than in the configuration shown in FIG. 1. Hence, the coupling coefficient change rate Δk is more stable in the case that two second-planar-coil lead-out wires 19 extend in different directions.

As a result, power transmission coil 11 is unsusceptible to a dimensional error between individual coils or a displacement between the primary and secondary coils.

### Fourth Exemplary Embodiment

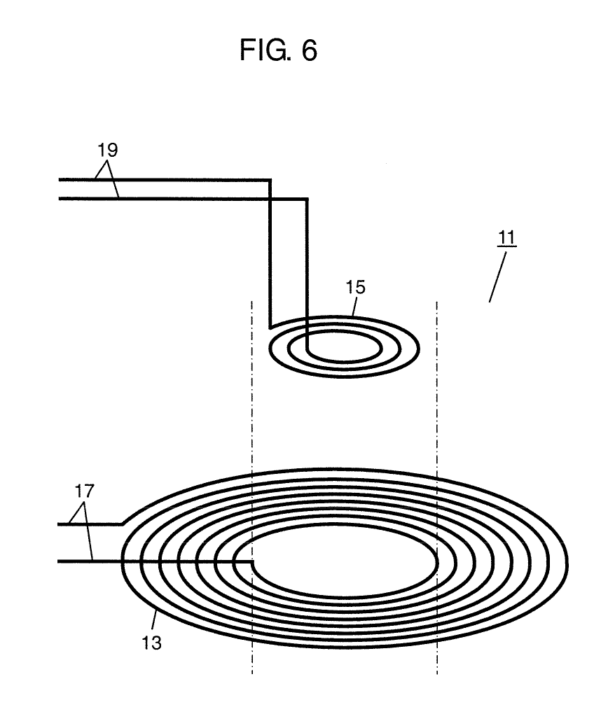

FIG. 6 is a perspective view of a power transmission coil of a fourth exemplary embodiment of the present invention.

As shown in FIG. 6, two second-planar-coil lead-out wires 19 of power transmission coil 11 have portions extending perpendicular to second planar coil 15.

This allows the distance to be large between first planar coil 13 and those portions of second-planar-coil lead-out wires 19 which extend opposite to first planar coil 13. In this configuration, the loop coil formed by second-planar-coil lead-out wires 19 less affects the magnetic field between first planar coil 13 and second planar coil 15, thereby stabilizing the coupling coefficient change rate Δk. As a result, power transmission coil 11 is unsusceptible to a dimensional error between individual coils or a displacement between the primary and secondary coils.

The construction and operation of power transmission coil 11 of the present fourth exemplary embodiment will now be described in detail. In FIG. 6, like components are labeled with like reference numerals with respect to FIG. 1, and the following description will be focused on the features of the fourth exemplary embodiment.

In FIG. 6, two second-planar-coil lead-out wires 19 each have a portion extending perpendicular to second planar coil 15 from a point connected to second planar coil 15, and also have a portion that follows the perpendicular portion and is led out horizontally. The perpendicular portions increase the distance between first planar coil 13 and those portions of second-planar-coil lead-out wires 19 which extend opposite to first planar coil 13. This makes the loop coil formed by second-planar-coil lead-out wires 19 distant from first planar coil 13. Hence, the loop coil less affects the magnetic field between first planar coil 13 and second planar coil 15, thereby further stabilizing the coupling coefficient change rate Δk. As a result, power transmission coil 11 is unsusceptible to a dimensional error between individual coils or a displacement between the primary and secondary coils.

The longer the perpendicular portions of second-planar-coil lead-out wires 19, the less the loop coil affects the coupling coefficient change rate Δk, and the effect is finally saturated. For this reason, the minimum length of the perpendicular portions of second-planar-coil lead-out wires 19 so as to make the coupling coefficient change rate Δk sufficiently stable can be experimentally predetermined.

In the present exemplary embodiment, the perpendicular portions of second-planar-coil lead-out wires 19 are connected to second planar coil 15. Two second-planar-coil lead-out wires 19 both have a perpendicular portion in the present exemplary embodiment. Alternatively, however, only one second-planar-coil lead-out wire 19 that is connected to the end of second planar coil 15 at its center may have a perpendicular portion.

### Fifth Exemplary Embodiment

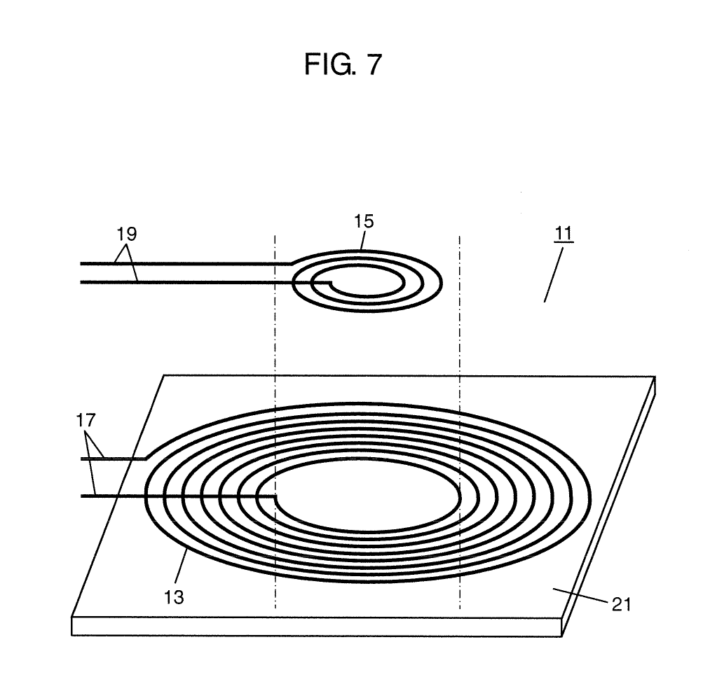

FIG. 7 is a perspective view of a power transmission coil of a fifth exemplary embodiment of the present invention.

As shown in FIG. 7, power transmission coil 11 includes magnetic body 21 on an opposite side to second planar coil 15 relative to first planar coil 13.

This configuration reduces magnetic flux leakage from first planar coil 13 to the side opposite to second planar coil 15. As a result, power transmission coil 11 is unsusceptible to a dimensional error between individual coils or a displacement between the primary and secondary coils, and also has high transmission efficiency.

The construction and operation of power transmission coil 11 of the present fifth exemplary embodiment will now be described in detail. In FIG. 7, like components are labeled with like reference numerals with respect to FIG. 1, and the following description will be focused on the features of the fifth exemplary embodiment.

As shown in FIG. 7, magnetic body 21 is provided to first planar coil 13 on the side opposite to second planar coil 15, that is, on the bottom side of first planar coil 13 shown in FIG. 7. Magnetic body 21 may be made of ceramic such as magnetic metal or ferrite and be in the shape of a block, a plate, or a sheet. In the present fifth exemplary embodiment, magnetic body 21 is made of ferrite sheet.

This configuration reduces magnetic flux leakage of first planar coil 13 from the side having magnetic body 21, thereby suppressing a decrease in the power transmission efficiency due to the magnetic flux leakage. Power transmission coil 11 of the present exemplary embodiment has a coil configuration identical to that of the first exemplary embodiment, and therefore, the same effects as those of the first exemplary embodiment (such as being unsusceptible to a dimensional error between individual coils or a displacement between the primary and secondary coils). In addition to these effects, power transmission coil 11 of the present exemplary embodiment has high power transmission efficiency.

Magnetic body 21 described in the present fifth exemplary embodiment can be applied to the configurations of the second to fourth exemplary embodiments. This provides not only the effects obtained in the second to fourth exemplary embodiments but also the effect of high power transmission efficiency.

### INDUSTRIAL APPLICABILITY

The power transmission coil of the present invention, which is unsusceptible to a dimensional error between individual coils or a displacement between the primary and secondary coils, is useful particularly for wireless power feeding.

1. A power transmission coil comprising:
a first planar coil having an inner diameter ; and
a second planar coil having an outer diameter and being disposed opposite to the first planar coil,
wherein
a quotient of the outer diameter of the second planar coil and the inner diameter of the first planar coil is defined as an inner/outer diameter ratio;
a rate of change in a coupling coefficient between the first planar coil and the second planar coil is defined as a coupling coefficient change rate; and
the inner diameter and the outer diameter are determined in accordance with a correlation between the inner/outer diameter ratio and the coupling coefficient change rate so that the inner/outer diameter ratio has a value not more than a value at which a slope of the correlation begins to rise steeply.

2. The power transmission coil of claim 1, wherein the second planar coil is wound up as close to a center thereof as possible.

3. The power transmission coil of claim 1, further comprising two second-planar-coil lead-out wires connected respectively to each end of the second planar coil and extending in different directions.

4. The power transmission coil of claim 1, further comprising two second-planar-coil lead-out wires connected respectively to each end of the second planar coil, at least one of the two second-planar-coil lead-out wires having a portion extending in a direction perpendicular to the second planar coil.

5. The power transmission coil of claim 1, further comprising a magnetic body disposed on an opposite side to the second planar coil relative to the first planar coil.

6. The power transmission coil of claim 1, wherein the first planar coil is used for power feeding, and the second planar coil is used for power reception.

7. The power transmission coil of claim 2, wherein the second planar coil is wound up to the center of the second planar coil.

8. The power transmission coil of claim 3, wherein the two second-planar-coil lead-out wires extend in directions 180 degrees apart from each other.
